(19) United States
(12) Patent Application Publication
(10) Pub. No.: US 2012/0095929 A1
(43) Pub. Date: Apr. 19, 2012

(54) Method and system for selecting and filing intellectual property application in multiple countries

(76) Inventors: Savi Gupta, New Delhi (IN); Balwant Rawat, Gurgaon (IN)

(21) Appl. No.: 13/317,328

(22) Filed: Oct. 14, 2011

(30) Foreign Application Priority Data
Oct. 15, 2010 (IN) 2455/DEL/2010

(51) Int. Cl. G06Q 50/00

(52) U.S. Cl. 705/310

(57) ABSTRACT

A system and method enables Intellectual Property (IP) applicants to determine the target countries for filing an IP application and provides filing and formalities support. The method includes generating a comprehensive list of target countries, eliminating countries based on patentability laws, prioritising the remaining list of countries on IP and market-specific factors, and filtering the list based on the filing cost in each country and the applicant's IP filing budget.

### REFERENCE TO RELATED APPLICATIONS

This application claims priority from India Provisional Patent Application serial Number 2455/DEL/2010 (filed on Oct. 15, 2010 titled “System And Method Of Selecting And Filing An Intellectual Property Application In Multiple Countries”), the content of which is incorporated herein by reference.

### FIELD OF THE INVENTION

The present invention relates, in general, to filing an Intellectual Property (IP) application, and, in particular, to determining countries where an IP application should be filed.

### BACKGROUND

Intellectual Property strategy plays a key role in improving the competitive position of an organisation. With prudent use of available budgets and well thought after decision making, a company can boost its IP portfolio to excel globally.

Filing of IP applications, such as patent applications, industrial designs, utility models and trademarks, in multiple countries is one of the important decisions in formulating an organisation's IP strategy. To succeed in today's emerging and highly competitive global market, decisions for filing the IP applications in various countries (foreign filing) need to be taken cautiously, ensuring a balanced distribution of budgets and maximization of returns.

The foreign filing strategy should naturally follow the global business; a detailed analysis must be tailored to an individual commercial situation. It is often not practical, efficient or cost-effective for an applicant to file an IP application in all the countries across the globe. Therefore, the target countries for IP protection must be carefully selected.

Unfortunately, in practice, the filing decisions are primarily based on subjective criteria such as individual experiences and past track record. This may negatively impact the future value of the business and cause irreparable harm in the long run if an important (or potentially important) country/jurisdiction is not selected for patent protection.

### SUMMARY

An object of the invention is to provide a method for determining the target countries for filing an IP application and provides filing and formalities support.

Another object of the invention is to provide a system for determining the target countries for filing an IP application and provides filing and formalities support.

Yet another object of the invention is to evaluate multiple countries with respect to technology, commercialization and organizational factors to decide for filing an IP application.

Another object of the invention is to provide multiple factors and tools to evaluate multiple countries with respect to technology, commercialization and organizational factors to decide for filing an IP application.

Yet another object of the invention is to provide a user with automated filing and formalities support for filing an IP application in multiple countries.

The present invention provides a system and method for determining the target countries for filing an IP application and provides filing and formalities support. The invention quantifies future implications associated with filing of an IP application in a foreign country, enabling the organisation to make an informed decision. A computing system is provided for recommending one or more countries for filing an Intellectual Property (IP) application. The system includes an input module for specifying details of the IP application, a processing module configured for analyzing the details related to the IP applications based on a plurality of parameters, and an output module for providing a recommended set of countries where the IP application should be filed based on the analysis of the processing module. The processing module includes a list generation module for generating an exhaustive list of countries for potential filing of the IP application, and a prioritization module for arranging the list of countries in an order of priority.

The method for recommending one or more countries for filing an Intellectual Property (IP) application includes collecting one or more details of the IP application. Based on the details and a plurality of parameters, an analysis is done and a list of countries is identified. The list of countries is then prioritized in an order from most appropriate for filing to the least one. Subsequently, a user is provided with a recommended set of countries for filing the IP application.

### BRIEF DESCRIPTION OF DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain the various principles and advantages of those embodiments, and in which:

FIG. 1 is a schematic diagram illustrating an IP filing decision system for determining countries for filing an IP application, according to an embodiment of the present invention;

FIG. 2 is a screenshot illustrating a graphical user interface (GUI) for accessing the IP filing decision system, according to an embodiment of the present invention;

FIG. 3 is a screenshot illustrating a GUI for the online questionnaire filled by a user, according to an embodiment of the present invention;

FIG. 4 is a screenshot illustrating a GUI for representing the recommended list of countries, according to an embodiment of the present invention; and

FIG. 5 is a flowchart illustrating a method for determining the target countries for filing an IP application, according to an embodiment of the present invention.

The system and method components have been represented, where appropriate, by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Various embodiments of the invention provide a method and a system for determining one or more target countries for filing an IP application and providing filing and formalities support.

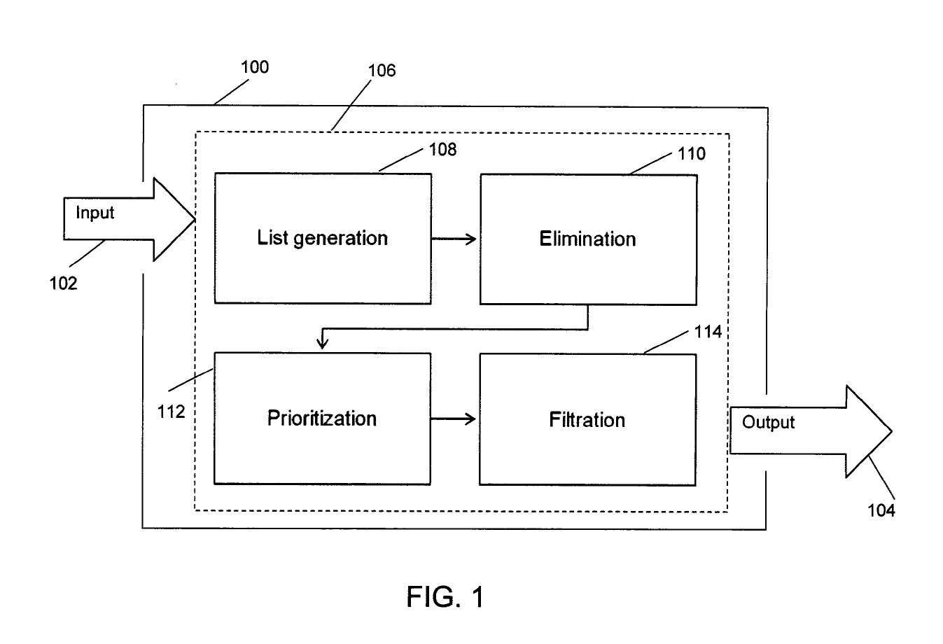

FIG. 1 is a schematic diagram illustrating an Intellectual Property (IP) filing decision system 100 for determining countries for filing an IP application according to an embodiment of the present invention. IP filing decision system 100 includes an input module 102 and an output module 104 inter-connected with a processing module 106. Input module 102 may be an online questionnaire that may be filled by a user on his/her computer system to specify details of an IP application. IP filing decision system 100 processes the information provided by input module 102 to provide an output as depicted in output module 104. The output may be a recommended list of one or more countries where the IP application should be filed. According to another embodiment, output module 102 may also include an interface for providing filing and formalities support along with estimated costs for filing per country/jurisdiction.

According to an embodiment of the invention, the user provides data points to input module 102 that may include information from prior research findings done by the user. Prior research information may include IP statistical data for each country, geographical patent classification information, technology maturity or advancement opportunity, market size, competitive environment, filing and prosecution cost, etc. The user input data may also include ‘corporate information’, such as sales locations, manufacturing locations and names of the competitors, and ‘invention-specific information’, such as relevant IP Classification System (IPCS) class (for example, International Patent Classification System, IPC, for patents and Nice Classification for trademarks), the budget for filing the IP application, the number of claims, number of pages of specification, and the number of words in the specification for calculating translation cost.

These above-mentioned inputs may also need to be periodically updated. The tables below indicate exemplary requirements from each category and the frequency for update. The updating frequency can be changed for the user input data as well as for the prior research data.

Prior Research Data

| | | Type of | Updating |
|---|---|---|---|
| | Data Set | Data | Frequency |
| 1 | IP enforcement ratings for each | Standard | Annual |
| | country | | |
| 2 | List of subject matter disqualified | Standard | Annual |
| | for IP protection for each country | | |
| 3 | List of top countries sorted | Standard | Six |
| | according to IP counts in each | | months |
| | IPC class | | |
| 4 | IP filing cost (in USD) for each | Standard | Six |
| | country | | months |
| 5 | List of top countries sorted | User | Quarterly |
| | according to IP counts of | specific | |
| | competitors in each country | | |
| 6 | List of top countries sorted | User | Annual |
| | according to market size for each | specific | |
| | relevant industry | | |

User Input Data

| S. | | Updating |
|---|---|---|
| No. | Data Set | Frequency |
| 1 | List of competitors | Annual |
| 2 | Sales locations | Annual |
| 3 | Manufacturing locations | Annual |
| 4 | IPC class for relevant | Per |
| | invention | transaction |
| 5 | Selection of category of | Per |
| | invention | transaction |
| 6 | Budget for filing the particular | Per |
| | application | transaction |
| 7 | Number of claims | Per |
| | | transaction |
| 8 | Number of pages of | Per |
| | specification | transaction |
| 9 | Number of words in the | Per |
| | specification for calculating | transaction |
| | translation cost | |

Processing module 106 includes a list generation module 108, an elimination module 110, a prioritization module 112 and a filtration module 114. In an embodiment, elimination module 110, prioritization module 112 and filtration module 114 may be software modules, hardware modules, firmware modules or a combination thereof.

List generation module 108 utilizes data obtained from input module 102 to generate an exhaustive list of countries where the IP application may potentially be filed. This list may include the countries where (a) the product/service (based on the innovation) may be sold; (b) the product/service may be manufactured; (c) the existing competitors operate; (d) the majority of IP applications are filed for the technology domain of product/service (for example, based on the same IPCS class); or (e) where the research and development centre is located. It will be apparent to one skilled in the art that more parameters may be included to create a basis for populating a list of countries where an application may be filed.

Elimination module 110 eliminates countries depending on external factors, for example, IP laws and regulatory requirements. For example, the countries where the existing patentability laws do not allow patenting of product/service domain may be excluded from the exhaustive list generated by list generation module 108.

Prioritization module 112 prioritizes the list of remaining countries based on a set of IP-specific and market-specific factors using statistical modelling techniques. These may include weighted average on the current or projected values of one or more of the following four factors: (1) IP Enforcement, (2) IPCS Class-vs.-Country, (3) Industry Landscape and (4) Competition Positioning.

The IP enforcement factor indicates the strength of the IP enforcement system in a given country. If a country has a higher rating, it means that it has a better IP enforcement system than a country with a lower rating. There are international agencies such as the World Intellectual Property Organization (WIPO) and the International Property Rights Index (IPRI) that publish such lists on an annual basis. Based on the statistical data from these reports, IP enforcement factor for each country can be calculated. In an exemplary embodiment, the IP enforcement factor may be calculated as a factor of number of patent issuance versus number of total filings in a given year or time period.

According to the IPCS class-vs.-country factor, a country is rated higher than another if the number of IP filings (in the IPCS class for the IP application) in the first country is greater than that in the second one. A prior research may be conducted using numerous IP databases to identify the number of IP applications filed for each IPCS class across all countries.

According to the industry landscape factor, a country is rated higher if the market size or market attractiveness for the industry domain (corresponding to the IP application or the corresponding technology domain) in that country is greater than that of the other country. A prior research may be conducted for all the industry segments for the product categories of the IP applicant's company and its competitors to estimate the worldwide and country-wise market size. Accordingly, based on the prior research findings, a rating against each country may be assigned to reflect the maturity and opportunity of the industry domain.

According to competition positioning factor, a country is rated higher if the number of IP filings by the company's (IP assignee) competitors in that country is greater than that in the other country. A prior research may be conducted for the IP applications filed by competitors of the IP applicant's company in the last 10 years to come up with such a list.

According to an embodiment of the invention, an overall rating of the countries may be calculated using statistical tools. One such tool is weighted average, where different weights may be assigned to the above-mentioned factors based on the industry best practices or even the company's corporate policy. The weights can be dynamically changed by the user during the interaction with input module 102 or via prioritization module 112.

According to another embodiment, regression analysis can be done using data for the above-mentioned factors, such as IP Enforcement, IPCS Class-vs.-Country, Industry Landscape and Competition Positioning to forecast the future values of these factors. Accordingly, the output generated is in accordance with future market and IP trends, which is useful as the term of a patent is typically 20 years. Hence, the decision on countries where the IP application should be filed can be made taking into account both the past trends and the expected future trends.

According to yet another embodiment of the invention, a Tie Breaker module (not shown) may be included, which is activated if there is a tie among the overall ratings computed at the prioritisation stage. In such a case, the rating as per the Industry landscape factor can be used to determine the overall rating, followed by the competition positioning factor and the IPCS class-vs.-country factor. The order and importance of the above factors can be customised by the user as per the situation.

Filtration module 114 filters the prioritized list generated by prioritization module 112 based on the cost of IP filing in each country and the company's available budget to produce the output. In another embodiment of the invention, the list can also be filtered based on the return on investment (ROI). The ROI for a country can be calculated by the expected monetary benefit that is expected by filing the IP application in that country.

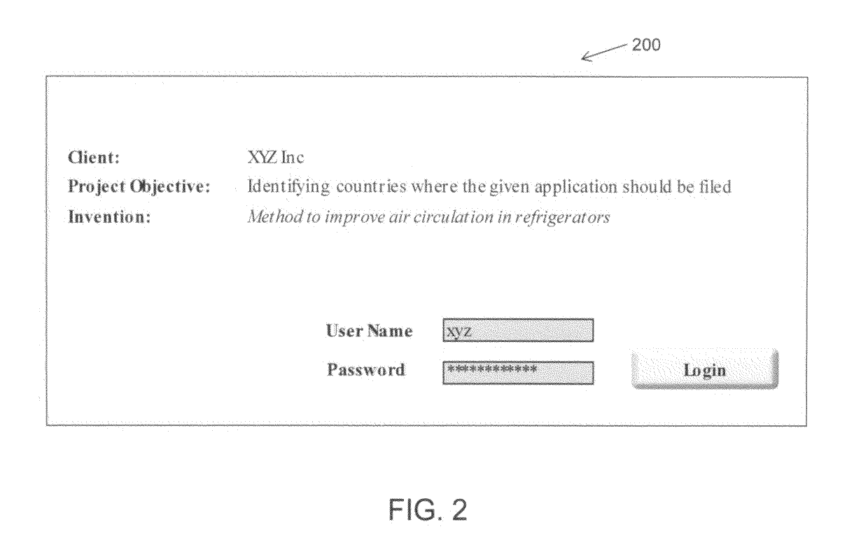

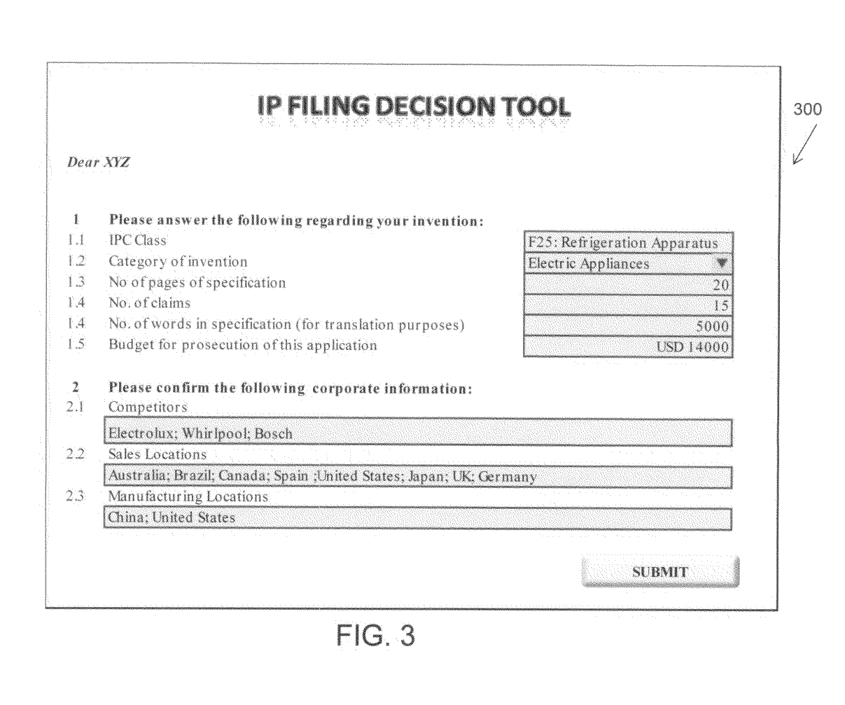

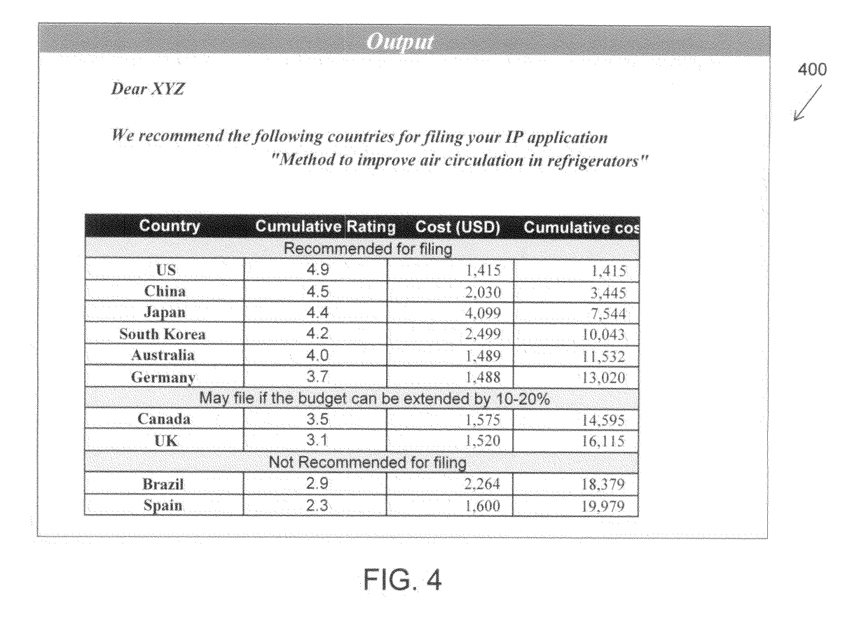

FIGS. 2, 3 and 4 illustrate exemplary snapshots of graphical user inputs (GUI) of IP filing decision system 100 according to various embodiments. It is assumed that an IP attorney or an analyst, hereinafter referred to as a user, of a firm XYZ is interested in identifying countries for filing an IP application titled ‘method to improve air circulation in refrigerators’. The user can securely log in a web-based tool provided by IP filing decision system 100, shown as snapshot 200 in FIG. 2. Upon successful login, the user is directed to the interface provided by input module 102, where the user can fill an online questionnaire, shown as snapshot 300 in FIG. 3. The questionnaire may include invention-specific inputs and corporate-specific information. The questionnaire is processed by list generation module 108, elimination module 110, prioritization module 112 and filtration module 114 to generate the output, shown as snapshot 400 in FIG. 4. According to output module 102 for this specific case, the recommended list of countries includes the US, China, Japan, South Korea, Australia and Germany. If the budget can be stretched by 10-20%, the filing can be done in Canada and the UK. In contrast, the countries where the filing is not recommended include Brazil and Spain.

According to another embodiment of the invention, output module 102 may include the logical explanation of how the countries have been selected and organised in the given order. A link may be included to show a detailed methodology for providing the recommendation. Additional links may be shown providing past, current and projected values of the IP-specific and market-specific factors. Additionally, IP office deadlines, if applicable, can be shown for filing and prosecuting the IP application in the respective countries.

According to yet another embodiment of the invention, output module 102 may include clickable instructions for ordering services related to foreign filing of the application and related support. In such a case, if the users decide so, they can select countries and immediately order filing the IP application in those countries. In an embodiment, links may be provided on the same webpage about the local attorney information, details of the overall costs, relevant filing forms, the methodology for filing and formalities support, and the suggested deadline for various tasks. In an embodiment, relevant filing forms such as Power of Attorney and assignment forms can also be filled by the users using the same platform. The webpage may be connected to a payment gateway through which the users can pay for the total costs incurred. After the filing of the IP application, the docketing and formalities support may be provided to the user.

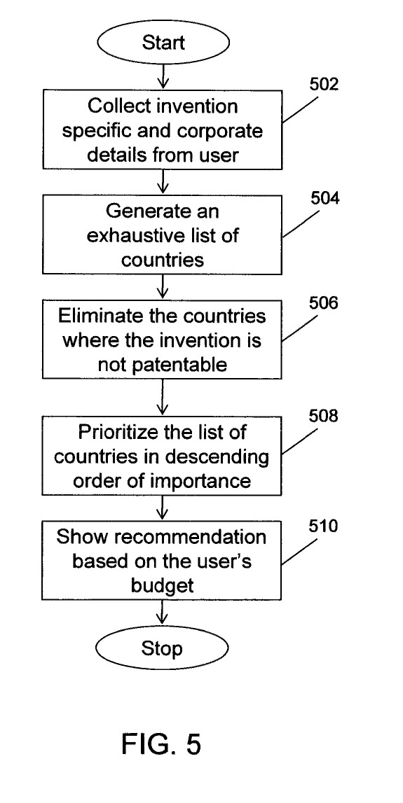

FIG. 5 is a flowchart illustrating a method for determining the target countries for filing an IP application, according to an embodiment of the present invention. At 502, invention-specific and corporate inputs are collected from a user over a web-based interface. At 504, these inputs are used to generate an exhaustive list of countries where the IP application can potentially be filed. At 506, the exhaustive list is scanned to remove those countries where IP filing is not feasible because of external factors, such as patentability laws, regulatory requirements and political situation in the country. For example, countries where the existing patentability laws do not allow patenting of product/service domain (such as software or business methods) can be excluded from the exhaustive list. At 508, the list of remaining countries is prioritised based on a set of IP-specific and market-specific factors using statistical modelling techniques. At 510, the prioritised list is filtered based on the cost of IP filing in each country and the company's available budget to produce a list of countries recommended for IP filing.

According to another embodiment of the invention, the output can be used to determine the attractiveness of countries for a variety of purposes, such as IP filing, and destinations for selling the products/services based on the IP application, and to identify locations for research and development (R&D). Accordingly, the invention can be used at different stages of the product lifecycle. For example, R&D destinations can be selected based on a country's attractiveness for the technical domain of the research. The IP division of a corporation can select relevant countries for IP protection at the time of screening ideas for potential IP applications, before filing an IP application or even after filing. For example, in case a user files a PCT application, the user may select more countries where national stage filing is desired.

Advantages of some embodiments of the present invention include quick, objective and scientific decision making by users, who may be IP applicants or IP attorneys. The invention helps in getting the best return on investment (ROI) for the applicant's limited budget.

In the foregoing specification, specific embodiments have been described. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of the present teachings.

The system for determining the target countries for filing an IP application, as described in the present invention or any of its components, may be embodied in the form of a computer system. Typical examples of a computer system include a general-purpose computer, a programmed microprocessor, a micro-controller, a peripheral integrated circuit element and other devices or arrangements of devices that are capable of implementing the steps that constitute the method of the present invention.

The computer system comprises a computer, an input device, and a display unit. The computer further comprises a microprocessor. The microprocessor is connected to a communication bus. The computer also includes a memory. The memory may include Random Access Memory (RAM) and Read Only Memory (ROM). The computer system also comprises a storage device, which can be a hard disk drive or a removable storage drive, for example, floppy disk drive, optical disk drive, etc. The storage device can also include other similar means for loading computer programs or other instructions into the computer system. The computer system also includes a communication unit, which allows the computer to connect to other databases and the Internet through an Input/Output (I/O) interface. The communication unit allows the transfer as well as reception of data from other databases. The unit may include a modem, an Ethernet card or any similar device that enables the computer system to connect to databases and networks such as LAN, MAN, WAN and the Internet. The computer system allows users to provide input through the input device, accessible to the system through I/O interface.

The computer system executes a set of instructions that are stored in one or more storage elements to process the input data. The storage elements may also hold data or other information as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. Further, the software may be in the form of a collection of separate programs, a program module with a larger program or a portion of a program module, as in the present invention. The software may also include modular programming in the form of object-oriented programming. The processing of input data by the processing machine may be in response to user commands, results of previous processing or a request made by another processing machine.

While various embodiments of the present invention have been illustrated and described, it will be clear that the present invention is not limited to these embodiments only. Numerous modifications, changes, variations, substitutions and equivalents will be apparent to those skilled in the art without departing from the spirit and scope of the present invention.

What is claimed is:

1. A computing system for recommending one or more countries for filing an Intellectual Property (IP) application, the system comprising:
an input module for specifying details of the IP application;
a processing module configured for analyzing the details related to the IP applications based on a plurality of parameters, the processing module comprising:
a list generation module for generating a list of countries for potential filing of the IP application;
a prioritization module for arranging the list of countries in an order of priority; and
an output module for providing a recommended set of countries where the IP application should be filed based on the analysis of the processing module.

2. The system of claim 1, wherein a user provides corporate information to the input module.

3. The system of claim 1, wherein a user provides invention specific information to the input module.

4. The system of claim 1, wherein the prioritization module prioritizes the list of countries based on a set of IP-specific and market-specific factors using one or more statistical modelling techniques.

5. The system of claim 1, wherein the processing module further comprises an elimination module to remove specific countries from the list based on one or more external factors.

6. The system of claim 1, wherein the processing module further comprises a filtration module for filtering the prioritised list of countries based on IP filing cost in each country and an overall budget for foreign filing.

7. The system of claim 1, wherein the output module includes a Graphical User Interface (GUI) for providing filing and formalities support along with estimated costs for filing per country/jurisdiction.

8. The system of claim 1, wherein the output module comprises one or more links for providing a user with a plurality of filing options.

9. The system of claim 1, wherein the output module comprises an electronic payment link for providing a user with options to pay filing fees for the IP application being filed in one or more countries.

10. A method performed by a computer of recommending one or more countries for filing an Intellectual Property (IP) application, the method comprising:
collecting one or more details of the IP application;
analyzing the one or more details related to the IP applications based on a plurality of parameters;
identifying a list of countries based on the one or more details and the plurality of parameters;
prioritizing the list of countries in an order of priority; and
providing a recommended set of countries for filing the IP application.

11. The method of claim 10, wherein prioritizing the list of countries is based on a set of IP-specific and market-specific factors using one or more statistical modelling techniques.

12. The method of claim 10 further comprising eliminating specific countries from the list of countries based on one or more external factors.

13. The method of claim 10 further comprising filtering the prioritised list of countries based on IP filing cost in each country and an overall budget for foreign filing.

14. The method of claim 10 further providing filing support data along with estimated costs for filing for each country.

15. The method of claim 10, wherein the one or more details of the IP application comprises corporate information and invention specific information.

16. A computer program product for use with a computer, the computer program product comprising a computer-usable data storage device storing a computer readable program code embodied therein for recommending one or more countries for filing an Intellectual Property (IP) application, the computer readable program code comprising:
program instructions for collecting one or more details of the IP application;
program instructions for analyzing the one or more details related to the IP applications based on a plurality of parameters;
program instructions for identifying a list of countries based on the one or more details and the plurality of parameters;
program instructions for prioritizing the list of countries in an order of priority; and
program instructions for providing a recommended set of countries for filing the IP application.

17. The computer program product of claim 16 further comprising program instructions for eliminating specific countries from the list of countries based on one or more external factors.

18. The computer program product of claim 16 further comprising program instructions for filtering the prioritised list of countries based on IP filing cost in each country and an overall budget for foreign filing.

19. The computer program product of claim 16 further comprising program instructions for providing filing support data along with estimated costs for filing for each country.
